(19) United States
(12) Patent Application Publication
(10) Pub. No.: US 2022/0041250 A1
(43) Pub. Date: Feb. 10, 2022

(54) MOTORIZED VEHICLE

(71) Applicant: MOONBIKES MOTORS, Saint-Gervais-Les-Bains (FR)

(72) Inventor: Nicolas MURON, Paris (FR)

(21) Appl. No.: 17/280,562

(22) PCT Filed: Sep. 27, 2019
(86) PCT No.: PCT/EP2019/076316

§ 371 Date: Mar. 26, 2021

(30) Foreign Application Priority Data
Sep. 27, 2018 (FR) 1858913

(51) Int. Cl. B62M 27/02

(52) U.S. Cl. CPC B62M 27/02; B62M 2027/028; B62M 2027/025

(57) ABSTRACT

A motorized vehicle includes a front part equipped with at least one steering skid intended to be steered by a handlebar, a rear part including a chassis rigidly attached to a tracked propulsion means and driven by a transmission mechanism configured to be powered by a motor. The motorized vehicle is configured such that the motor is housed inside a wheel of the transmission mechanism forming a drive wheel of the propulsion means called a motor wheel. The propulsion means being supported by a bogie comprising an upper bogie rigidly attached to the chassis and a lower bogie, connected together by a suspension mechanism. The lower bogie is articulated with respect to the upper bogie. The motor wheel is rigidly attached to the lower bogie at the rear thereof.

The present invention relates to a vehicle comprising a front part provided with at least one steering skid intended to be steered by handlebars, a rear part comprising a frame that is rigidly connected to a propulsion means of the caterpillar track type, and driven by a transmission mechanism designed to be driven by a motor. In particular, the invention relates more generally to a lightweight, nomadic, off-road vehicle for all terrain (snow, mud, sand, soil, tarmac) which makes it possible to facilitate individual mobility (such as the general public), in particular in snowy regions.

Individual movement in snowy regions is traditionally achieved by virtue of vehicles of the “snowmobile” type, also referred to as “skidoos.”

The conventional snowmobile is a motorized vehicle, typically driven by means of one or two caterpillar tracks, and equipped with skis to ensure the steering of the vehicle. This is a powerful vehicle (engine power generally greater than 90 kW) which is suitable for long distances and for transporting heavy loads. It is traditionally provided with a heat engine. The modern snowmobile generally comprises a single caterpillar track having a large contact surface (0.8 m²), providing the vehicle with a thrust that is suitable for the power of its engine. Its front skis, its large caterpillar track (generally 50 cm), and the dimensions of the seat, make for a comfortable and stable vehicle that is suitable for long distances.

The power of the snowmobile, its comfort, and its stability, suitable for long distances, result in a heavy piece of equipment (over 230 kg for most models) of large dimensions (over 3 m long).

Its heat engine results in a piece of equipment which is a source of air and sound pollution, which generally gives it a negative image. Moreover, the snowmobiles comprise a significant number of parts and are expensive to produce.

On account of its power, its dimensions, and the pollution which it generates, the “conventional” snowmobile is not suitable for individual mobility in a winter sports resort, and more generally in an urban environment. It is not suitable, for example, for the development of a self-service “snowmobile park” intended for the general public, in order to facilitate individual mobility in a winter sports resort.

On account of its mass and its dimensions, the snowmobile is not a nomadic piece of equipment. On account of its characteristics, it is not suitable to be transported by its user other than on a trader towed by a vehicle, or in a lorry. On account of its characteristics, it is not easy to transport, nor is it suitable for mail-order selling.

A prototype snowmobile having an electric motor is currently being developed by some companies. The known prototypes in development are generally presented as having most of the characteristics of “conventional” snowmobiles (mass, dimensions, design), with the only difference being the single electric motor.

Snowmobiles having electric motors are known, having reduced dimensions. This type of vehicle is generally based on a pre-existing frame of a “conventional” junior snowmobile (i.e. for a child), and provided with an electric motor. Other than the electric motor, this type of vehicle has most of the characteristics of “conventional” junior snowmobiles (mass, dimensions, design).

Conversion systems are also known for adapting motorcycles to snow, said systems being made up of a narrow caterpillar track and a monoski. The compatible motorcycles are generally only motorcycles having a heat engine. Although lighter and less bulky than a “conventional” snowmobile, a motorcycle thus equipped appears to be difficult to transport by a user other than in a lorry or by means of a trailer.

The object of the present invention is that of proposing a solution which corresponds to a development of said types of known motorized vehicles, which makes it possible to overcome all or some of the above-mentioned disadvantages, and in particular to propose a nomadic motorized vehicle which facilitates individual mobility and is easy to transport.

In other words, the aim of the invention is that of proposing a motorized vehicle of this kind having a simplified design which, on account of its reduced mass, its low bulk, and its design, is easy to transport by its user, easy to use, and suitable for travelling in an urban or a non-urban environment.

For this purpose, the invention relates to a motorized vehicle comprising a front part provided with at least one steering skid intended to be steered by handlebars, a rear part comprising a frame that is rigidly connected to a propulsion means of the caterpillar track type, and driven by a transmission mechanism designed to be driven by a motor, the motorized vehicle being characterized in that it comprises a mechanical connection for mechanically connecting the front part to the rear part, the mechanical connection being detachable.

A “detachable” mechanical connection is intended to mean a mechanical connection having the possibility of being manually dismantled without destroying the assembly mode thereof, and thus guaranteeing the integrity of the mechanical connection.

Such a connection also means a mechanical connection which does not require the use of a complicated tool for the assembly and/or disassembly thereof, nor specific knowledge for use thereof.

By virtue of such a combination of features, the motorized vehicle is easy to dismantle into at least two parts, by way of a simple movement or by means of a small number of operations. Furthermore, once dismantled the vehicle has a reduced bulk.

According to an advantageous feature, in a storage position, i.e. dismantled and/or folded, the vehicle has a combined measurement of a length and a circumference of less than or equal to 419 cm, and more preferably a weight of less than 70 kg. By virtue of such a feature, the vehicle can be marketed via an Internet platform and supplied through distance selling. Indeed, these dimensions are considered to be standard dimensions for parcels intended to be transported by specialist transport companies such as UPS.

According to a particular technical feature, the vehicle comprises a gripping means that is designed to allow for mechanical connection to be assembled and dismantled manually, in particular without the aid of a specific tool.

Namely, the gripping means may be directly attached to the mechanical connection, such that simply moving it allows for the assembly and dismantling of said connection. Such a gripping means may for example be a lever associated with a cam which allows for tensioning, for tightening, or release of tension, for loosening, the element to be tightened, of the collar type. This type of fixing is commonly referred to as “quick coupling.”

However, the gripping means may be separable and remote from the connection, for example in order to prevent dismantling of the vehicle by an ill-intentioned person wishing to attempt to steal it. Said gripping means is thus in the form of a simple tool, for example of the key type.

Alternatively or in addition, the detachable mechanical connection comprises a detachable mechanical fixing means, for example of the screw-nut type, which can be dismantled using a simple tool, such as a standard screwdriver.

The motor is preferably an electric motor supplied by a battery.

According to a particular technical feature, the front part comprises a linkage which forms a framework, the detachable mechanical connection connecting the linkage of the front part to the frame of the rear part. In this way, the vehicle is lightweight and compact.

Advantageously, the front part comprises a front arm, for example of the fork type, connected on one side to the steering skid(s) and on the other side to the handlebars, the linkage being connected to said front arm in a detachable manner such that it can be dismantled.

According to a feature, the front part and/or the linkage can be dismantled into a plurality of pieces, allowing them to be dismantled and then packaged in the form of a kit, for transport thereof.

Alternatively or in addition, the linkage and/or the front arm preferably comprise internal articulations, so as to be folded once dismantled.

By virtue of these features, the vehicle is compact and, once dismantled, can be reduced to a limited volume.

According to a technical feature, the detachable mechanical connection between the front and rear parts is articulated so as to ensure a pivot connection having a horizontal axis extending transversely with respect to a longitudinal reference axis of the vehicle. A feature of this kind makes it possible to improve the ability of the motorized vehicle for passage, and the maneuverability thereof.

Preferably, said pivot connection is damped, for example by means of an energy storage means connecting the front and rear parts.

Preferably again, the handlebars comprise electrical control and braking means of the motor, and the vehicle comprises an electrical connection device between the front part and the rear part. It also comprises a mechanical connection device which can be dismantled, for the brake cable, between the front and rear part.

Advantageously, the rear part is self-supporting, i.e. once the front part and the rear part are dismantled in the region of the detachable mechanical connection, the rear part is stable and does not fall. In this manner, dismantling is facilitated for one person. In addition, the rear part may be provided with a stabilization device such as a stand or stabilizer wheels.

According to a feature, the propulsion means is supported by a bogie, the bogie comprising an upper bogie that is rigidly connected to the frame, and a lower bogie, said bogies being interconnected by a suspension mechanism, the lower bogie having at least one degree of freedom with respect to the upper bogie.

This feature makes it possible to further improve the ability of the motorized vehicle for passage, and the maneuverability thereof.

Said degree of freedom is preferably a rotation about an instantaneous axis of rotation, also referred to as “ICR,” which is preferably located longitudinally with respect to the vehicle, in a zone located to the right of a contact surface between the propulsion means and the ground.

According to another aspect, the invention also relates to a motorized vehicle comprising a front part provided with at least one steering skid intended to be steered by handlebars, a rear part comprising a frame that is rigidly connected to a propulsion means of the caterpillar track type, and driven by a transmission mechanism designed to be driven by a motor, the motorized vehicle being characterized in that the motor is received in a wheel of the transmission mechanism which forms a drive wheel of the propulsion means.

The assembly made up of the motor and the transmission mechanism can also be referred to as the driving sprocket.

Integrating a motor into a wheel of the transmission mechanism allows for improved compactness and a simplified design while guaranteeing effective driving of the propulsion means, and improves the mechanical output of the caterpillar tracked train.

These advantages provided by the motor integrated into a drive wheel, also referred to as an in-wheel motor, are independent of the detachable mechanical connection for connecting the front part to the rear part.

The combination of these two features is, however, advantageous for combining all the advantages.

Thus, a motorized vehicle according to the invention comprising a detachable mechanical connection for connecting the front part to the rear part as described above may comprise an in-wheel motor according to the invention as well as all the features dependent thereon. Vice versa, a motorized vehicle according to the invention comprising an in-wheel motor forming a drive wheel as mentioned above may comprise a detachable mechanical connection for connecting the front part to the rear part as described above, as well as all the features dependent thereon.

Advantageously, the propulsion means is supported by a bogie, the bogie comprising an upper bogie that is rigidly connected to the frame, and a lower bogie, said bogies being interconnected by a suspension mechanism, the lower bogie being articulated with respect to the upper bogie and having at least one degree of freedom with respect to the upper bogie. This degree of freedom may be a rotation about an instantaneous axis of rotation, preferably located on a straight line referred to as the “caterpillar track force line” which is colinear with respect to the resultant of the propulsion forces exerted by the in-wheel motor on the caterpillar track.

According to an embodiment, the wheel of the transmission mechanism which forms a drive wheel of the propulsion means is rigidly connected to the lower bogie, at the rear thereof. The braking of the vehicle is ensured by means of a brake such as a disk brake that is rigidly connected to the rotating part of the in-wheel motor or driving sprocket, and the laws of which are rigidly connected to a fixed point of the lower bogie.

The static regulation of the tension of the caterpillar track is achieved by horizontal translation of the in-wheel motor by virtue of oblong holes in the region of the lower bogie. A blocking mechanism such as a screw/nut system allows the motor pins to be blocked in translation, at the desired position. A similar mechanism (oblong hole+screw/nut) is installed in order to regulate the position of the brake laws with respect to the lower bogie.

Preferably again, the lower and upper bogies are interconnected by means of at least one suspension and a connecting rod.

In a particular technical configuration, the lower and upper bogies are interconnected by means of two suspensions (one front suspension, one rear suspension) and at least one connecting rod.

In a particular technical configuration, the bogie is designed such that the caterpillar track is triangular, i.e. having three returns, the wheel forming the in-wheel motor being rigidly connected to the lower bogie, at the rear thereof. An additional wheel may be placed, waiting, at the rear of the upper bogie.

According to an embodiment, the wheel of the transmission mechanism inside which the motor is received comprises, on its circumference, a plurality of cells which are separated by stiffeners, the stiffeners preferably being inclined with respect to a radial direction of the wheel.

According to an embodiment, the wheel of the transmission mechanism inside which the motor is received is borne by a shaft that is connected to the lower bogie, at least one damping joint being arranged between the shaft of the wheel and the lower bogie, preferably accompanied by at least one plate of a harder material than the joint.

According to an embodiment, the frame comprises at least four oblong half holes which are designed to receive portions, preferably located at the ends, of at least two shafts borne by the bogie, preferably by the upper bogie. Said oblong half holes are preferably open at the bottom and are arranged in pairs on either side of the frame, a shaft of the bogie being connected to two oblong half holes in the vicinity of the ends thereof.

By virtue of its design, the snowmobile according to the invention is also easy to dismantle and reassemble in order to facilitate the transport thereof by its user or the mail-order selling thereof.

In summary, the invention proposes a motorized vehicle of the skidoo type which, by virtue of the design thereof, is easy to dismantle and reassemble, in order to facilitate the transport thereof by its user, or its mail-order selling thereof, and which can be transported for example in a wheeled suitcase, or even in a parcel, in the trunk of a car, in an elevator, in a gondola, or in a light aircraft.

Further features and advantages of the invention will become clear from the following description, given merely by way of example and with reference to the accompanying drawings, in which:

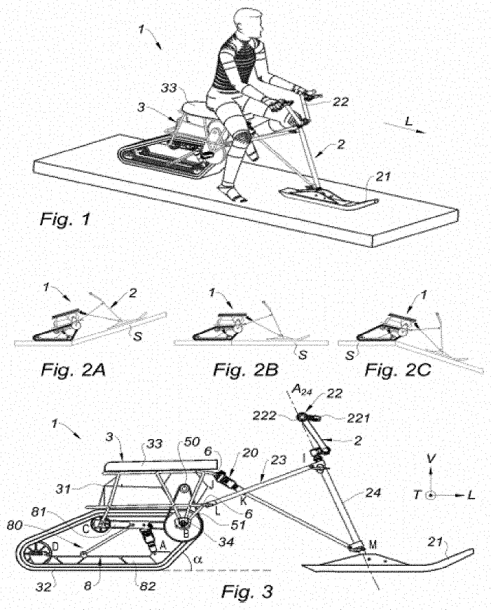

FIG. 1 is a perspective view of a motorized vehicle according to an embodiment, shown having a driver;

FIGS. 2A, 2B and 2C are profile views of a motorized vehicle according to this embodiment;

FIG. 3 is a side view of a motorized vehicle according to another embodiment;

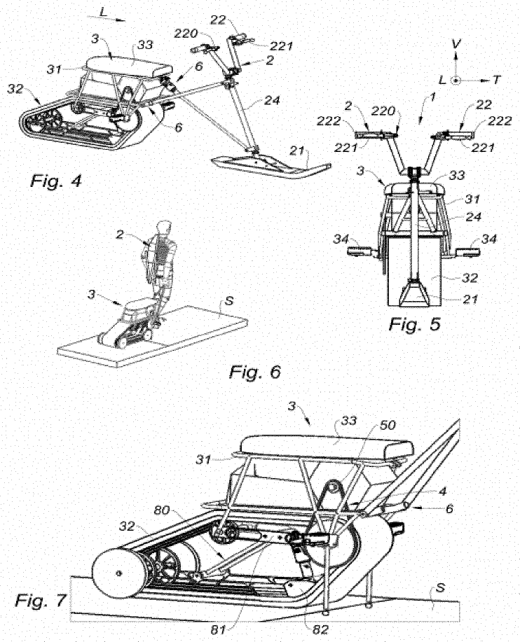

FIG. 4 is a perspective view of a motorized vehicle according to the embodiment of FIG. 3;

FIG. 5 is a front view of a motorized vehicle according to the embodiment of FIG. 3;

FIG. 6 shows a motorized vehicle according to this embodiment, in a transport configuration;

FIG. 7 shows the rear part of a motorized vehicle according to this embodiment, in a transport configuration;

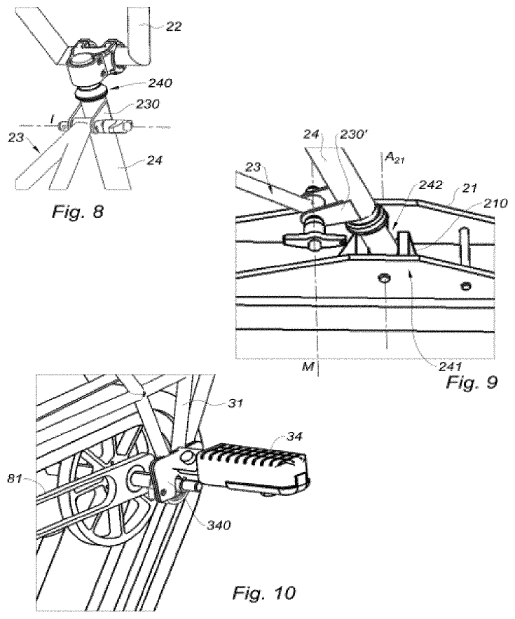

FIGS. 8, 9, 10, 11, 12, 13, 14, 15, 16, 17, 18, 19 and 20 are detailed views of different parts of the motorized vehicle according to this embodiment;

FIG. 21 is a schematic view of a motorized vehicle according to an embodiment, comprising a non-articulated bogie;

FIGS. 22A and 22B are schematic views of two front suspension configurations of a vehicle according to different embodiments, the vehicle comprising a non-articulated bogie;

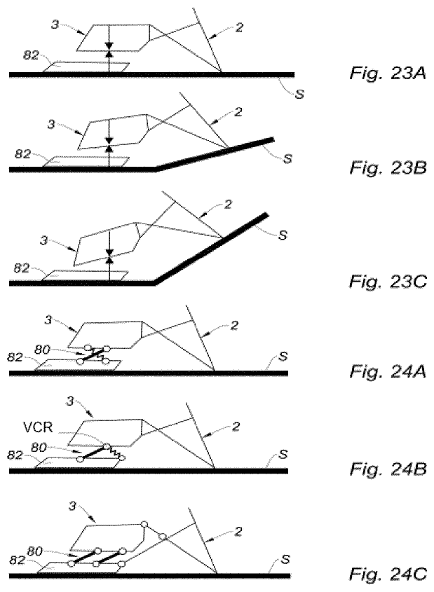

FIGS. 23A, 23B and 23C are schematic views of a motorized vehicle according to an embodiment, comprising an articulated bogie, shown having three different ground profiles;

FIGS. 24A, 24B and 24C are schematic views of three configurations of the suspension mechanism between an articulated lower bogie and upper bogie of a vehicle according to different embodiments;

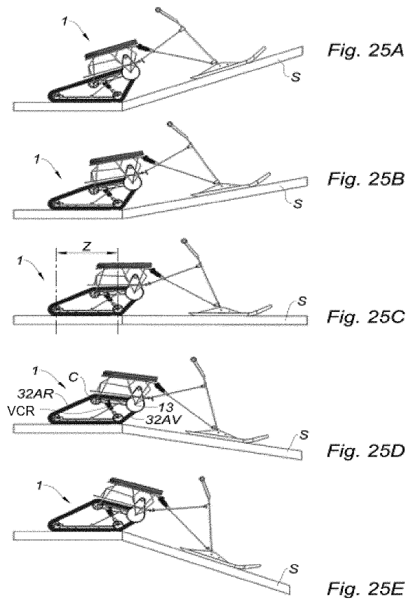

FIGS. 25A, 25B, 25C, 25D and 25E are side views of a motorized vehicle according to the embodiment of FIGS. 1 and 2, in different profiles of breaks in the gradient of the ground on which the vehicle is moving;

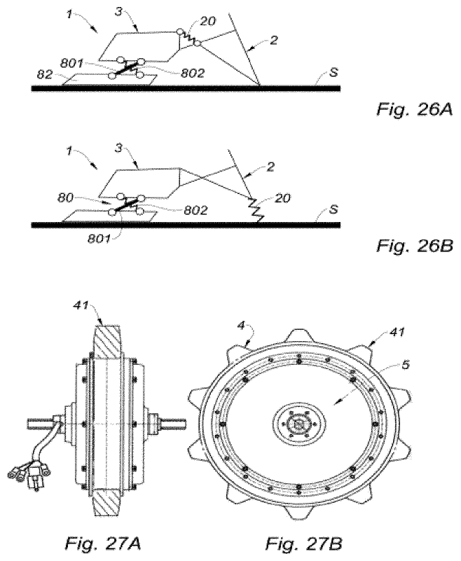

FIGS. 26A and 26B are schematic views of two front suspension configurations of a vehicle according to different embodiments;

FIGS. 27A and 27B are a front view and a side view of an in-wheel motor or driving sprocket according to an embodiment;

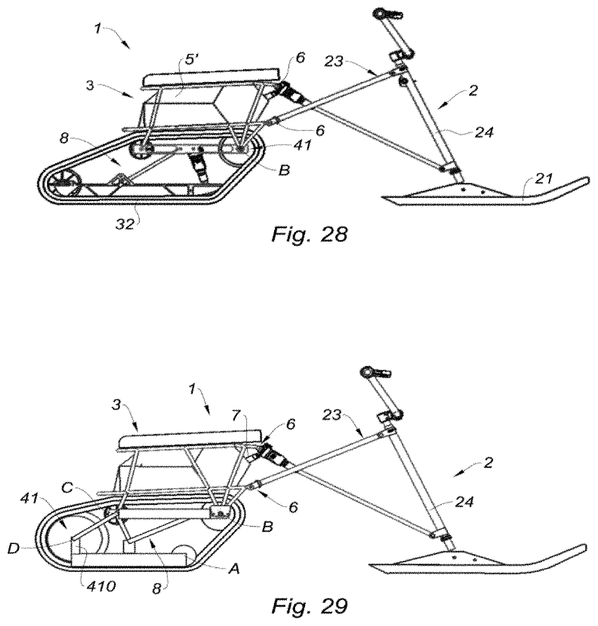

FIG. 28 is a side view of a motorized vehicle according to an embodiment comprising an in-wheel motor, in which the in-wheel motor is borne by an upper bogie, at the front thereof;

FIG. 29 is a side view of a motorized vehicle according to an embodiment comprising an in-wheel motor, in which the in-wheel motor is borne by a lower bogie, at the rear thereof;

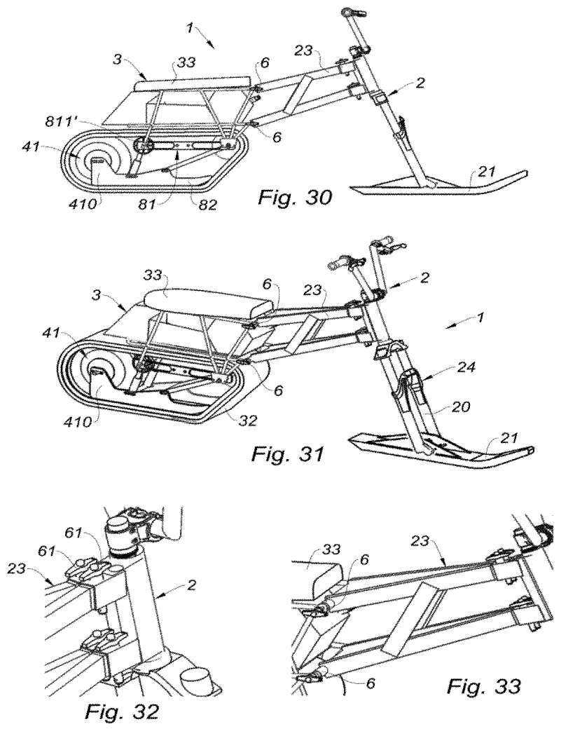

FIGS. 30, 31, 32, 33, 34 and 35 are general and detailed views of a motorized vehicle according to another embodiment;

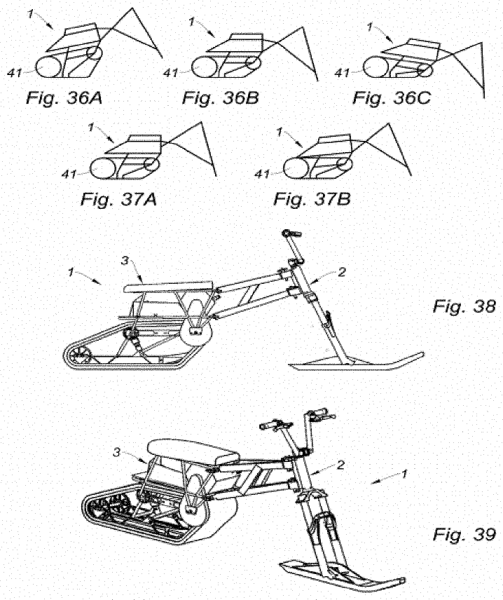

FIGS. 36A, 36B and 36C are schematic views of a motorized vehicle according to an embodiment, in different positions between the lower and upper bogies;

FIGS. 37A and 37B are schematic views of a motorized vehicle according to an embodiment, in different positions according to the state of the rear suspension;

FIGS. 38 and 39 are side and perspective views of a motorized vehicle according to another embodiment;

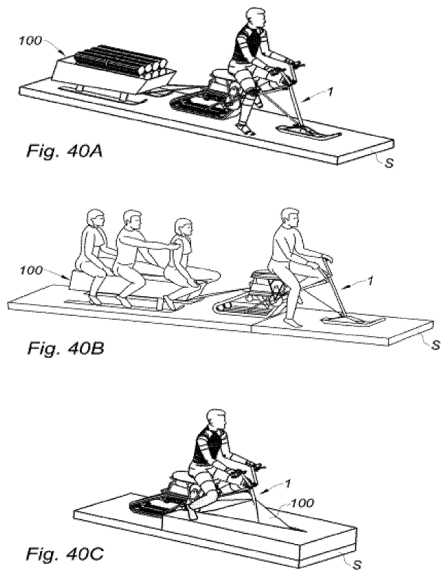

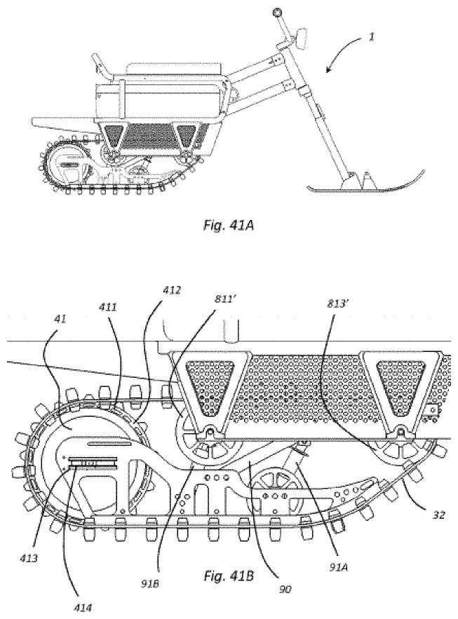

FIGS. 40A, 40B and 40C show a motorized vehicle according to an embodiment, according to different usages;

FIGS. 41A and 41B show a vehicle according to another embodiment, and a detail of the bogie.

In the description and the claims, in order to clarify the description and the claims, in a non-limiting manner the terms longitudinal, vertical and transverse are used with reference to the trihedral L, V, T indicated in the drawings.

Throughout the figures, identical or similar reference signs represent identical or similar members or sets of members.

Moreover, the terms “upper,” “lower,” “vertical,” and their derivatives, refer to the position or to the orientation of an element or a component, said position or said orientation being considered when the motorized vehicle is positioned on the ground, in the usage configuration,

FIG. 1 is a schematic view of motorized vehicle 1 according to an embodiment.

The motorized vehicle t comprises a front part 2 provided with at least one steering skid 21 intended to be steered by handlebars 22, a rear part 3 comprising a frame 31 that is rigidly connected to a propulsion means 32 of the caterpillar track type, and driven by a transmission mechanism 4 designed to be driven by a motor 5 such as an electric motor 5 supplied by a battery (not shown).

According to the invention, the motorized vehicle 1 comprises a mechanical connection 6 for mechanically connecting the front part 2 to the rear part 3, the mechanical connection 6 being detachable.

In this way, the motorized vehicle 1 comprises two front 2 and rear 3 parts which are separable but which can be easily mechanically assembled and electrically connected (without particular tools, without force, with a small number of operations).

Preferably, each of said front 2 and rear 3 parts have a reduced bulk and mass, such that they are easy to handle by the user. As a result, the motorized vehicle 1 is each to transport on foot via castors, in the boot of a car, in an elevator, in a gondola, or in a light aircraft, or even in a parcel.

This design is shown in particular in FIGS. 6 and 7. The front part 2 is foldable and is made up of a front arm 24 that is rigidly connected to a linkage 23 which is articulated such that it can be folded and, by way of a design essentially comprising a set of tubular elements, the bulk thereof is reduced such that it can be folded into a simple rucksack. It will be noted that the front part can also, alternatively, or in combination, be dismountable.

The mechanical assembly between the front part 2 and the rear part 3 may be achieved by various known means, for example by pins or other assembly elements which make it possible to achieve a mechanical connection between the pieces without specific tools, at most with the aid of standard tools, for example in the case of assembly of the screw-nut type, also referred to as a bolt. Said mechanical connection 6 will be described in detail in the following.

The front part 2 comprises a front arm 24, for example of single-arm type as shown in the drawings, or of the fork type, the front arm 24 being connected on one side to the steering skid 21 and on the other side to the handlebars 22.

The front arm 24 comprises a stem 240 that is located at the upper end thereof and is fixed by fitting which can be dismantled, and allows for connection to the handlebars 22 (see FIG. 8).

The handlebars 22 are fitted to the stem 240, and thus to the front arm 24, by clamping. The device for clamping the handlebars to the stem of the front arm 24 is preferably easy to dismantle, i.e. without tools, such as a clamping collar or clip.

The front arm 24 comprises a lower end having a connection element 241 for connection to the steering skid 21 which contributes to the pivot connection 242 thereto.

Said pivot connection 242 is preferably detachable, i.e. can be easily dismantled in order to be able to easily separate the steering skid 21 from the front arm 24.

The steering skid 21 may typically comprise a monoski, and more generally at least one ski 21. A solution of the monoski type is preferred with respect to the reduced compactness of the front part 2 and improved reactivity and precision of the direction, while a solution having two skis 21 may be retained in order to provide improved stability to the vehicle 1.

The steering skid 21 allows for steering and floating of the motorized vehicle 1 in an unconsolidated environment, such as on powder snow, sand or mud. The rotation of the handlebars 22 is communicated to the steering skid 21 via the front arm 24 that forms a steering column, in particular by way of a rotation of the main pin A₂₄ according to which the front arm 24 extends (see FIG. 3).

The rotation of the steering skid 21 with respect to the front arm 24, about a horizontal, in particular a pin A₂₁ in parallel with the transverse axis T of the vehicle 1, is left free, but the extent thereof may be limited and/or it may be damped by means of a damping device 210.

In a technical configuration, the damping of the rotation between the steering skid 21 and the front arm 24 is achieved by a foam block 210 that is rigidly connected to said steering skid 21 and collides with the steering arm 24 beyond a particular angular progression. This is more lightweight than adding a damping jack between the ski 21 and the steering column 24, and allows for dismantling of the steering skid 21.

The steering skid 21, i.e. the ski or skis, is preferably equipped with a longitudinal rail (not shown) on the lower surface thereof in order to increase the engagement on the ground S.

The front part 2, for example the front arm 24 or the steering skid 21, preferably comprises a fixing interface in order to ensure the fixing thereof to an optional module 100 at the front of the vehicle, such as a moldboard at the front, used for pushing the snow onto the roadside, thus ensuring a snowplow function (see FIG. 40C). The pin A₂₁ of the connection between the steering skid 21 and the front arm 24, forming the steering column, is detachable and can be dismantled without tools, in this case of the pin type, and is secured.

The front part 2 comprises a linkage 23 that forms a framework, the linkage 23 being rigidly connected to the front arm 24 and being articulated with respect to said front arm 24. Said articulations in particular make it possible, once the front 2 and rear 3 parts are dismantled, to allow for folding of the front part 2 in order to make it compact in the folded position. It will be noted that the front part can also, alternatively, or in addition, be dismountable into several pieces.

The articulations of the linkage 23 are formed by pivots of horizontal shafts in parallel with the transverse axis T of the vehicle 1.

In a general manner, the linkage 23 is formed of a set of tubular elements, in particular connecting rods, the front part 2 being furthermore damped by a damper 20, said set mainly having two functions:
to mechanically connect the steering skid 21, the front arm 24 forming the steering system, and the handlebars 22, to the rear part 3, via the linkage 23, and
to be involved in the suspension (damper) and the kinematics of the vehicle 1.

The front arm 24 comprises a rotatably mounted column inside a steering tube that is rigidly connected to the linkage 23.

The linkage 23 of the front part 2 is connected to the frame 31 of the rear part 3 by means of the detachable mechanical connection 6.

According to an embodiment shown for example in FIG. 3, said linkage 23 is formed by two crossed uprights JS and IM which are connected to the articulations I and S of the front arm and to the articulations J and L of the rear part, J, I, M and L denoting the articulations of the horizontal axes in parallel with the transverse axis T of the vehicle 1.

In a more detailed manner, and with reference to the embodiment shown in FIG. 3 in particular, the linkage 23 comprises:
a framework (IL) of the linkage 23 which is mounted so as to be rotatable with respect to the frame 31 in the region of two pivots at L, having an axis in parallel with the transverse axis T, and with respect to the steering tube IM (pivot at I, having an axis in parallel with the transvers axis T).
It is made up, for example, of:
   two tubes (IL) which are positioned substantially side-by-side, transversely and convergently at I (aluminum alloy, steel alloy, composite materials, or other equivalent material).
   The two ends of the tubes (at L) are equipped with a device which is designed to allow for quick dismantling with respect to the frame 31, such as a piercing which can receive a pin clip;
   a connection tube at K, arranged in parallel with the transverse axis T and connecting the two tubes IL.
   Said tube comprises two connection pivots, each having a horizontal axis in parallel with the transverse axis T of the vehicle 1, said pivots being detachable, preferably able to be dismantled without tools, comprising a damper 20 JK, and comprising a connecting rod KM;
   a connection element for connection to the steering tube IM, such as a female pivot.
connection elements for connection to the steering tube (IM) of the front arm 24, which is formed of an aluminum alloy, steel alloy, composite materials, or other equivalent material.

The steering tube IM is equipped with connection elements for connection to the linkage 23 framework, for example two lugs 230 which receive the female pivot of the framework (see FIG. 8). The connection between the framework IL and the steering tube 23 is thus achieved by a system that can be dismantled, such as a pin.

The steering tube IM is equipped with elements for connection to the connecting rod (KM). For example, two lugs 230′ receive the female pivot of the connecting rod KM (see FIG. 9). The connection between the connecting rod KM and the steering tube is thus achieved by a system that can be dismantled, such as a pin.

The steering tube IM comprises, at the two ends thereof, elements for connection to the steering column (which is inside the steering tube);
the connecting rod KM (aluminum alloy, composite materials, or other equivalent material) is mounted so as to be rotatable (and such that it can be dismantled) at K with the tubes IL and at M with the front arm 23.

The framework IL, the front arm 23, and the connecting rod KM are rotatably mounted (3 pivot connections), they form an articulated lattice having 0 internal degrees of freedom, or an internal degree of freedom of zero. This has the advantage of limiting the fitting torques at the connections (pivots in parallel with the transverse axis T), making the structure operate mainly under traction/compression rather than under bending, and to thereby gain in lightness, and to facilitate the dismantling.

A solution in which the framework IL, the steering tube 23, and the connecting rod KM are mounted in a fitted manner, while being able to be dismantled, can be conceivable for reasons of production costs or ease of maintenance.

The handlebars 22 comprise electrical control means 220 of the motor 5, in particular an acceleration control, and also comprises braking controls, security devices, and antitheft protection. The handlebars 22 also comprise elements for displaying parameters to the user.

The electrical control means 220 of the electric motor 5 preferably further comprises two additional controls; a first control allowing for activation and deactivation of an “anti-skid” function, and a second control allowing for a “turbo” function.

In detail, the handlebars 22 comprise the following elements:
lateral handles 222, i.e. a right-hand handle and a left-hand handle;
an accelerator control device (for example a control suitable for being controlled by a user's finger such as their thumb);
a braking device comprising at least one brake lever 221 that is rigidly connected to the handlebars 22, the braking device comprising a main brake and an emergency brake;
an “on” button that is designed such that, when it is activated, the propulsion means 32 of the caterpillar track type drives the motorized vehicle 1 to the rear, in order to make it reverse;
electronic members that allow for parameters to be displayed to the user, originating from a controller or sensors of the rear part 3; said parameters are for example: the instantaneous speed of the vehicle, the instantaneous voltage and current of the electric motor 5, the temperature of the motor 5, the level of the battery that forms the source of energy, the distance travelled, etc.;
the controls allowing for activation and deactivation of an “anti-skid” function: the “anti-skid” function makes it possible to reduce the control range of the accelerator with respect to that programmed by default in the parameters of the controller; the activation thereof reduces the maximum voltage that can be delivered to the terminals of the motor by the controller, and thus the maximum speed of rotation of said motor. The user may activate this function in order to limit the loss of adhesion and thus the sliding of the caterpillar track 32 with respect to the ground S, when the equipment moves on ground having a low coefficient of friction, such as ice, or on a significant gradient;
the controls allowing for activation and deactivation of a “turbo” function: the “turbo” function makes it possible to increase the value of the maximum current deliverable to the motor by the controller, with respect to that programmed by default in the parameters of the controller; the value by default limits the risk of overheating of the winding(s) the motor, which could damage the jacks thereof and lead to destruction of the motor 5. The user can activate this function in order to increase, temporarily or otherwise, the maximum power that can be delivered to the motor by the controller. Having left the recommended usage range, the user will monitor the temperature of the motor by virtue of the display of said value, placed on the handlebars 22. In the event of a programmed temperature value in the controller being exceeded, said controller is designed to cut the supply of the motor 5 and to signal this to the user via a warning light located on the handlebars. The user must wait for the temperature to drop below this increment value in order to restart the vehicle 1. This feature makes it possible to reinforce the fun aspect of driving the motorized vehicle 1, and also favors the use thereof in recreation or sports races in winter sports resorts;
one or more bright optics such as headlights.

The detachable mechanical connection 6 connects the linkage 23 of the front part 2 to the frame 31 of the rear part 3.

The motorized vehicle 1 comprises an electrical connection device 7 between the front part 2 and the rear part 3, so as to allow for the assembly and dismantling of the two parts, both mechanically and electrically.

The motorized vehicle 1 comprises a dismantlable mechanical connection device between the brake cable of the front part 2 and that of the rear part 3, so as to allow for the assembly and dismantling of the two front 2 and rear 3 parts.

In turn, the rear part 3 comprises a frame 31 that is formed by a tubular assembly defining an interior space inside which in particular a motor unit 5′ is received, which motor unit comprises the motor 5 and other power means (such as a battery, a controller, and electronic circuits), security means such as sensors, emergency stop interfaces, and cooling members intended for cooling the motor 5 and other components in order to prevent any overheating.

In particular, the power means comprises:
the electric motor 5;
a controller, in particular a speed variator;
a power relay;
an energy reserve or accumulator, in particular an electric battery, for supplying the motor 5 with electrical energy;
a battery protection circuit (battery management system or “BMS”): a circuit of this kind protects the accumulator against overvoltages (braking, recharging), undervoltages (total discharge) and overheating.

Preferably, the power means is designed such that they can operate in motor mode and in generator mode, both in the forward and in the backward direction. In other words, a torque is preferably selected which can operate in the “4 quadrants,” i.e. allowing the “motor” and “generator” operation, in the two directions of rotation (forward and backward direction):
quadrant 1; motor, forward direction
quadrant 2: generator/brake, backward direction
quadrant 3: motor, backward direction
quadrant 4: generator/brake, forward direction

The power means further comprises other electronic elements, such as a high-power electronic circuit, a low-power electronic circuit, an energy recovery circuit (braking and descent), a wiring network, a sealed switch such as a power-up switch, a sealed plug for recharging the accumulators, and a connecting plug for parameterizing the controller.

The energy recovery is performed by means of a motovariator (motor torque+variator) which returns energy to the accumulator during descent or upon braking, by means of the battery protection circuit (BMS).

The accumulator can be recharged in the following manners:
by opening a cover hatch for accessing the battery, disconnecting and removing the battery, and then charging said battery by way of an external charger (with the user, or elsewhere);
by way of a suitable plug present on the vehicle 1, which may allow for recharging at terminals without having to remove the battery, for example; or indeed, by means of portable solar panels, such as solar panels on a flexible fabric.

The vehicle 1 further comprises security means and said power means such as an emergency stop switch (manual and anti-ejection) and a fuse circuit.

In order to avoid overheating of the power means, the vehicle 1 comprises cooling members, such as a forced ventilation system.

Under the effect of the resistance and its electrical conductors, the motor 5 has losses which are transformed into heat (Joule effect). In order to avoid too much heating from destroying the motor (for example by the melting of the varnish of the electrical windings), a cooling system is integrated into the “motor unit” 5′. It is made up of an air inlet, located in the vicinity of the motor 5 and on the lower part of the casing surrounding the motor unit 5′, and an air outlet which is also positioned in the vicinity of the motor and on the upper part of the casing. The air inlet comprises a chicane or labyrinth in order to prevent the penetration of water/snow/sand into the motor unit 5′. The air outlet does not necessarily comprise a chicane, the saddle 33 protecting said outlet from some of the external projections. A fan, which functions as an air extractor, is placed inside the frame 32, upstream of the air outlet. This direction of air circulation (bottom to top) is selected so as to travel in the same direction as the natural convection of the air. The position of these members is selected in order for the flow of fresh air to lick the motor 5 in the zones close to the windings. The enclosure of the battery or batteries will be isolated with respect to said flow of cold air in order to ensure good performance of the batteries (the negative temperatures reduce the capacity of the batteries).

Sensors such as temperature sensors are placed in the vicinity of elements capable of heating, such as the motor winding, such that it is possible to control the heat losses of the electric material in order to ensure its integrity.

In order to prevent the temperature of the battery from becoming too low and from adversely affecting its performance during extended parking of the vehicle in a cold outdoor environment (for example at night), a heating device (such as a resistor) may be placed in the vicinity of the batteries. Said heating device may be supplied by the main battery, or by a secondary battery. Said “heating” may be under servo control by a thermostat.

The motor unit 5′ comprising the motor 5 and the power means is confined in a sealed casing in order to protect it from attack from the outside.

This sealing is ensured around the motor shaft 50 by joints such as lip seals or equivalent (dynamic sealing), and by the use of access covers (not shown) with which the casing is equipped, said access covers comprising a double cover along the perimeter or the periphery of the opening, accompanied by joints such as flat seals made of elastomer and/or equivalents (static sealing).

The frame 31 supports a saddle 33 which allows at least one user to sit down. Toe clips 34 are also rigidly connected to the frame 31, on a lower part thereof.

For example, the front toe clips 34 may be fixed to a bearing holding connection plate 340 of the frame 31 in order to limit the passage of force into the frame 31 so as to provide the vehicle 1 with a benefit in terms of mass, for the dimensioning thereof (see FIG. 10).

Other pairs of toe clips 34 may be installed on the frame 31 in the event of the vehicle 1 being arranged to transport passengers on its saddle 33, in addition to the driver.

The propulsion means 32 of the caterpillar track type is located under the frame and is supported by a bogie 8.

In a general manner, the bogie 8 forms a guide system for driving and braking the vehicle 1.

The bogie 8 comprises an upper bogie 81 that is rigidly connected to the frame 31, and a lower bogie 82 which is located under the upper bogie 81.

The lower 82 and upper 81 bogies are interconnected by a suspension mechanism 80, the lower bogie 82 having at least one degree of freedom with respect to the upper bogie 81 in order to improve its passibility, its maneuverability, and driving comfort.

The mechanical transmission between the motor 5 and the bogie 8 is achieved by means of a belt 51 or a chain which is led by the rotation of the motor shaft 50 and makes it possible to drive a wheel or sprocket 813, which rotates the caterpillar track 32.

In a general manner, the bogie 8 is an articulated and damped mechanical system which allows for the caterpillar track 32 to be guided, rotated and kept under tension, and which allows for the suspension of the frame 31 and the user(s). It also contributes to the general kinematics of the vehicle 1, which will be explained in detail in the following.

The bogie 8 is made up of two subassemblies which are interconnected by one or more connecting rods (or “arms”) which are rotatably mounted (plane (O, L, V)), and by one or more suspensions which are also rotatably mounted (plane (O, L, V)):
the upper subassembly is referred to as the “upper bogie” 81 or “fixed bogie” and is rigidly connected to the frame 31 having a degree of freedom of zero, apart from possibly the structural deformation which is negligible:
the lower subassembly is referred to as the “lower bogie” 82, “movable bogie,” or indeed “slide,” and has, as a minimum, a degree of freedom with respect to the upper bogie 81: this is for example a rotation according to an axis referred to as the “instantaneous axis of rotation,” which is in parallel with the transverse axis T (cf. FIG. 25) and passes through a point referred to as the “instantaneous center of rotation.”

The primary structure of the upper bogie 81 is made up of two longitudinal parallel rails 810 (or two tubes) which are mechanically rigidly connected, ensuring the guidance of the caterpillar track 32 on the upper part thereof.

The upper bogie 81 is equipped with at least one free wheel 811 on the rear part thereof, in order to guide the caterpillar track 32 on the rear obtuse angle of its trajectory.

This (these) wheel(s) may be waiting, i.e. not permanently in contact with the caterpillar track 32, for example in the case of a caterpillar track 32 referred to as “triangular” having a generally triangular shape or more generally having three peaks or returns.

Other free wheels may equip the rails 810 in the region of the connections to the connecting rods and suspensions.

The upper bogie 81 is equipped with a shaft 812 which is rotatably mounted on the front part thereof, in order to ensure the driving, braking and guidance of the caterpillar track 32 via a drive pinion, also referred to as a sprocket 813, which is rigidly connected to the shaft 812.

The shaft 812 of the sprocket 813 is equipped with a drive crown which makes it possible to transmit and demultiply the motor torque, and a brake such as a disk brake which makes it possible to exert a braking torque between the upper solid body, formed by the upper bogie, and the shaft 813.

The shaft 812 may be fluted or grooved and equipped with keys. The shaft may also comprise free wheels on either side of the sprocket 813.

The sprocket 813 (and the shaft 812 thereof) is placed on the upper bogie 81 rather than the lower bogie 82, in order to protect it, by gravity, from the snow which could obstruct its toothing and thus disrupt the driving of the caterpillar track 32 or even bring about its derailment.

The shaft 812 of the sprocket 813 deliberately passes beyond the caterpillar track 32 on either side, in order to be able to mechanically connect the crown and the disk brake to the frame. In other words, the length of the shaft 812 is greater than the length of the caterpillar track 32.

The upper bogie 81 comprises at least two connection pins for connection to the frame 31, a front pin A81 (referred to as pin AV) and a rear pin A81′ (referred to as pin AR), which necessarily extend beyond either side of the caterpillar track 32.

On account of its length that is greater than the width of the caterpillar track 32, said shaft 812 may rub in the powder/sand and considerably increase the drag of the vehicle. It is desired to place said pin as high as possible, in order to increase the all-terrain nature of the vehicle.

Since the upper bogie 81 is connected to the frame by at least two pivots, there is no degree of freedom between said two members.

The front pin A81 is preferably coincident with the axis of the drive shaft 812.

The front end of the upper bogie 81 is placed in front of that of the lower bogie 82 in order for the caterpillar track 32 to have an angle of attack a (see FIG. 3) which makes it possible to:
progressively flatten, during its passage, the powder or other unevenness of the ground (unconsolidated) in order to increase the output of the caterpillar track 32 compared with a solution without an angle of attack; and
dampen the chocks in the case of ground unevenness.

The primary structure of the lower bogie 82 is made up of two longitudinal parallel rails 820 which are mechanically rigidly connected, ensuring the guidance of the caterpillar track 32 on the lower part thereof, and ensuring the contact between the caterpillar track 32 and the ground S on the lower surfaces of the two rails 820.

The rails 820 are equipped with anti-friction skids (not shown) in the region of the contact surface thereof with the caterpillar track 32, in order to reduce the friction, and thus the energy losses.

The caterpillar track 32 is grooved in order to be guided in its driving, by means of the rails 810, 820, free wheels 811, 821, and sprocket 813.

The lower bogie 82 is equipped with one or two free wheels 821 on the rear part thereof, in order to guide the caterpillar track 32 on the rear acute angle of its trajectory.

Other free wheels 821 may equip the rails 820 in the region of the connections to the connecting rods and suspensions, in order to reduce the friction at said points of passage of greater forces.

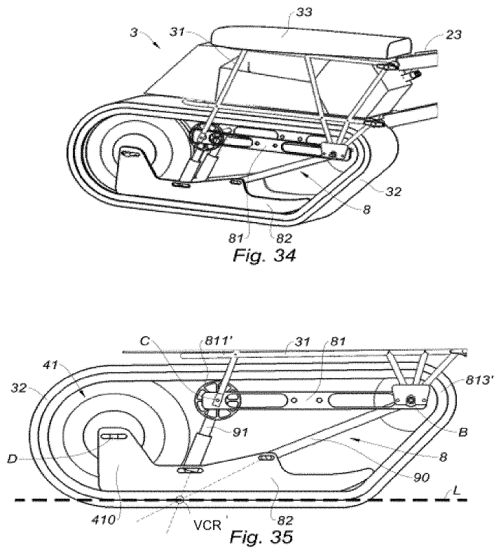

The lower bogie 82 is equipped with two free wheels 821 on the front part thereof, in order to guide the caterpillar track 32 on the front obtuse angle of its trajectory (see FIG. 25). As an alternative to the above, the free wheels may be replaced or completed with a sliding edge, as is shown in FIG. 3 for example (see also FIGS. 34 and 35, according to another embodiment).

The parallel lower rails 820 are spaced apart by a distance of less than the width of the caterpillar track 32, such that no part of the lower solid body passes beyond the caterpillar track 32 in a front view, in order to avoid friction when the vehicle 1 moves on ground that is not unconsolidated (powder, mud, sand).

The caterpillar track 32, which is guided by the bogie 8 described above, allows for adhesion to the ground, traction, and flotation in an unconsolidated environment (powder snow, sand, mud) of the vehicle 1.

The caterpillar track 32 comprises a part of a belt body having a continuous or endless loop having an outside surface intended to come into engagement with the ground S (crampons), and an inside surface which includes driven elements (bosses or holes).

The driven elements are designed to be engaged by a drive pinion, i.e. the sprocket 813.

The adhesion to the ground S, directly correlated to the maximum thrust of the vehicle, is proportional to the ground S/caterpillar track 32 contact surface, to the outside coating material of the caterpillar track 32 (rubber or equivalent, to increase the caterpillar track 32/ground S coefficient of friction, and to the geometry of the external crampons.

The geometry of the crampons may vary depending on the favored use of the vehicle 1: long crampons for unconsolidated ground (powder snow, sand, mud), and short for hard ground (ice, groomed snow).

The flotation of the vehicle 1 is proportional to the vehicle 1/ground S contact surface, i.e. caterpillar track 32/ground S and steering skid 21/ground S. Studs may be fixed to the outside surface of the caterpillar track 32 in order to increase its adhesion on ice or hard snow.

The torque originating from the electric motor 5 is demultiplied and then transmitted to the sprocket 813 by the chain or belt 51, then transmitted to the caterpillar track 32, in the form of force between the (engaged) driven elements of the sprocket and the (engaged) driven elements of the caterpillar track 32, as well as by adhesion on the caterpillar track/sprocket contact surface.

This force F is transmitted along the caterpillar track 32 by tension of the taut strand (BCD strand), then to the ground by adhesion in the region of the caterpillar track 32/ground S contact surface. This results in an acceleration g such that g F/m, where m is the driven mass (of the vehicle 1 and of the user(s)).

The resisting torque originating from the braking device is transmitted to the sprocket 813, then transmitted to the caterpillar track 32, in the form of force between the (engaged) driven elements of the sprocket 813 and the (engaged) driven elements of the caterpillar track 32, as well as by adhesion on the caterpillar track 32/sprocket 813 contact surface. This force −F is transmitted along the caterpillar track by tension of the taut strand (BAD strand), then to the ground by adhesion in the region of the caterpillar track 32/ground S contact surface. This results in a deceleration g such that g=−F/m, where m is the driven mass (of the vehicle 1 and of the user(s)).

The vehicle 1 preferably comprises a device for regulating the tension of the chain or belt 51, such as a tensioner, either dynamic or static.

The solution of static regulation is preferred, i.e. without a dynamic tensioner, in order to achieve gains in mass, friction, mounting simplicity, and noise. The force path between the motor 5 and the crown of the sprocket 813 was studied in order to limit the center-to-center distance variations (motor 5-crown 813) under significant chain or belt 51 forces. In order to achieve this, it is advantageous to design the vehicle 1 such that the axis of the connection between the caterpillar track 32 and the frame 31 is coincident with the drive shaft (bearing the crown that forms the sprocket 813). This furthermore limits the operation under bending of the frame 31 elements located between the connection pin B and the motor unit 5.

This static regulation of tension of the chain or of the belt 51 which forms the connection between the motor unit 5′ and the frame 31 will be achieved by means of 4 screw-nut-lock nut systems, in order to be able to regulate the tension of the chain/belt 51.

The vehicle 1 is preferably equipped with a tensioner of the caterpillar track 32. The rear part 3 of the vehicle 1, in particular the rails 820 of the lower bogie 82, each comprise an oblong hole 823 which allows for the translational regulation of the shaft D of the free wheels 822, forming a rear lower return angle (see FIG. 14).

The screw/nut/lock nut system allows for blockage of the shaft in a given position. This system allows for static regulation of the tension of the caterpillar track 32.

The frame 31 is thus of the vehicle is thus mechanically connected both to the bogie 8 and to the front unit 2.

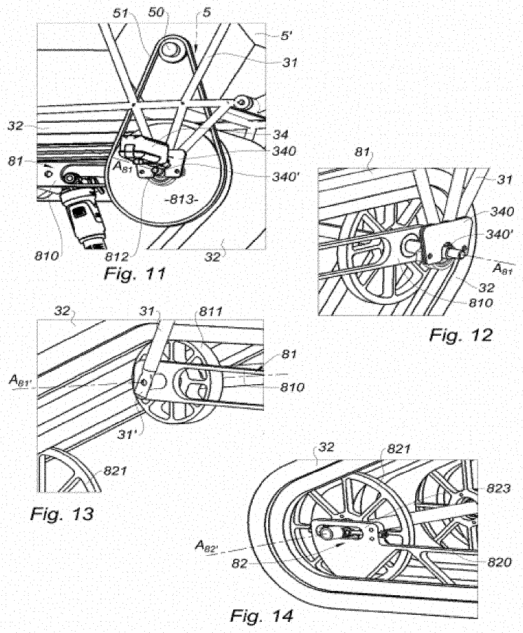

The interface between the frame 31 and the bogie 8 comprises a mechanical connection which can be dismantled and ensures that the frame 31 is fitted to the upper bogie 81, said mechanical connection preferably comprising a minimum of 2 pivot connections having an axis in parallel with the transverse axis T, and in particular one front connection and one rear connection:
front connection: the drive shaft 812 is mounted on two flanged bearings, a right-hand and a left-hand bearing, each flange of which is fitted to the frame 31 by fixings, in particular by means of a bearing holding plate 340 which is welded to the frame 31 and to which the toe clips 34 are furthermore rigidly connected.
According to the configuration shown, each plate 340 comprises an oblong half hole 340′ on the lower free edge, in order to facilitate the dismantling (see FIGS. 11 and 12). Thus, when the two fixings of the two bearings (right-hand and left-hand, i.e. 4 fixings) are removed, the frame 31 can be easily dismantled by lifting it vertically.
rear connection: since the rear pin A81′ is not rotatable, and since the free wheels 812 are mounted on ball bearings, the bogie 8 is connected to the frame 31 via two fixings that are located on either side of the pin and are coaxial with said pin. The shaft bearing said pin A81 will be equipped with threaded inserts for example. The ends 3 of the connection tubes of the frame 31 are crushed and pierced in order to receive the fixings. Thus, when the 2 fixings (right-hand and left-hand) are removed, the frame 31 can be easily dismantled by lifting it vertically.

A variant of these connections would consist in forming an oblong half hole on the free edge of the ends of the connection tubes of the frame 31, and for the pin to have its ends threaded.

As mentioned, the detachable mechanical connection 6 connects the linkage 23 of the front part 2 to the frame 31 of the rear part 3.

According to a feature, the mechanical connection comprises a gripping means 61 that is designed to allow for the manual assembly and dismantling of the mechanical connection 6.

Namely, the gripping means may be directly attached to the mechanical connection, such that simply moving it allows for the assembly and dismantling of said connection. Such a gripping means may for example be a lever associated with a cam which allows for tensioning, for tightening, or release of tension, for loosening, the element to be tightened, of the collar type. This type of fixing is commonly referred to as “quick coupling.”

In FIG. 16, for example, a gripping means of this kind is formed by a handle, referred to as a wing nut, which is rigidly connected to the swivel pin and secured by a push button.

However, the gripping means may be detachable, i.e. separable and able to be made remote from the connection, for example in order to prevent dismantling of the vehicle by an ill-intentioned person wishing to attempt to steal the vehicle. Said gripping means is thus in the form of a simple tool, for example of the key type.

Said gripping means is different from a tool in that it allows for direct cooperation with the mechanical connection, and that is very easy to use and very quick.

Preferably, “quick” is intended to mean a mechanical connection 6 which can be dismantled in a time period of less than a minute, preferably less than 20 seconds. Said time period may be slightly longer (of the order of a few minutes) in the case where the detachable mechanical connection 6 comprises a detachable mechanical fixing means, for example of the screw-nut type, which can be dismantled using a simple tool, such as a standard screwdriver.

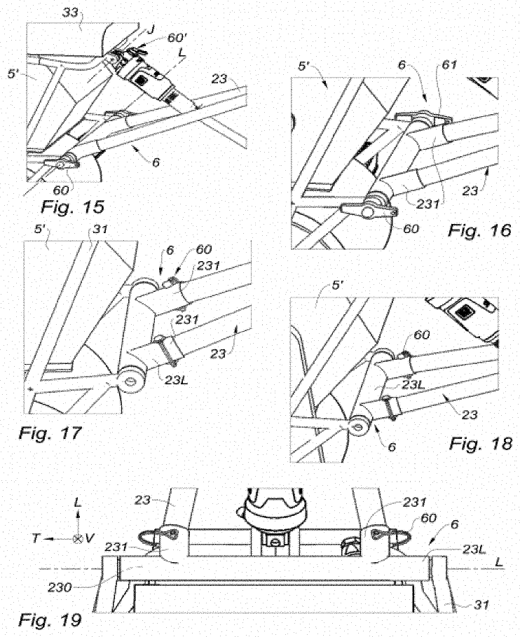

With reference to FIGS. 15 to 19 for example, the detachable mechanical connection 6 is articulated so as to ensure a pivot connection having a horizontal axis extending in parallel with the transverse axis T, or transversely with respect to a longitudinal reference axis L of the vehicle 1.

For the configuration having a damped fork (FIG. 30) (for which the linkage 23 has no degree of freedom), the pivots of the detachable connection 6 (upper (axis and lower (axis L)) are of interest in that they do not transmit torque via the axes L and T. This reduces the forces in the frame 31 (and thus allows for a benefit in terms of mass).

In particular, this fixing interface 6 between the front part 2 and the frame 31 of the rear part 3 comprises in particular:
a lower connection of the pivot connection type between the pin in parallel with the transverse axis T and the center L (see FIG. 3): the connection comprises at least one quick (pin or other) and secured (ball/clip) assembly and dismantling system 60,
an upper connection of the pivot connection type between the pin in parallel with the transverse axis T and the center J (see FIG. 3): the connection comprises at least one quick (pin or other) and secured (ball/clip) assembly and dismantling system 60′; it makes it possible to mechanically separate the front part 2 from the rear part 3, quickly and without tools.

In a configuration shown for example in FIGS. 5 to 20, the linkage 23 and the frame 32 are interconnected by a connection piece 23L that is rigidly connected, for example by fitting, to the front part 2 with the linkage 23, by means of a device 60 that allows for quick assembly and dismantling, such as two connections of the type of fitted concentric tubes, secured by a pin.

In order for this connection to be able to be dismantled, it is essential that the two starting points or tubular portions 231 of the connection piece 23L for pressing them in together with the linkage 23 have mutually parallel axes. In FIG. 19, the ends of the tubes of the linkage 23 are angled in order to be able to be fitted into the connection piece 23L.

Said connection piece 23L is mounted so as to be rotatable, by means of bearings, ball bearings or another equivalent device, with respect to a shaft 230 having a concentric axis L and rigidly connected to the frame 32, for example by two lateral fixings that are transversely spaced apart and form bearings at said shaft 230, at both ends thereof.

The connection between the connection piece 23L and the front part 2 may be associated with assembly difficulties, for example in the case of thermal expansion of the pieces. In this case, a possible variant is that of placing the rapid assembly and dismantling system 6 between the frame 32 and the shaft 230. In this scenario, the connection piece 23L would then be rigidly connected to the front part 2: the pin may be replaced by screws, or even a welded connection.

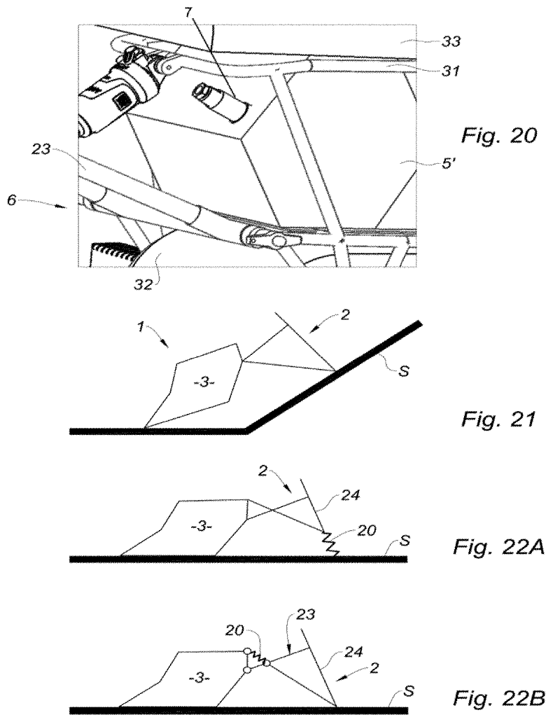

The electrical connection 7 (see FIG. 20) between the front part 2 and the rear part 3 is designed so as to allow for the assembly and dismantling of the two front 2 and rear 3 parts, both mechanically and electrically comprising in particular a sealed electrical connector, such as a connector of the type IP65 mini, male or female.

Said electrical connection 7 is also detachable so as to make it possible to electrically connect/disconnect the front unit 2 from the rear unit 3, rapidly and without tools.

On the rear part 3 thereof, the frame 31 further comprises a fixing interface for rear traction elements 100′ such as a trailer mounted on skids or skis (FIG. 40A), a sled for transporting passengers (FIG. 40B), or a track tracer such as a fabric.

In this case, a mechanical connection such as a pivot connection, ball joint, or fitted connection, allowing for the fixing of rear modules such as a sled, a traction cord, etc.

A sealed electrical connector is also provided in this case (for example of the type IP65 mini, male or female), which makes it possible to connect/disconnect a rear element of the vehicle.

This may be used for example for adding rear optics or headlights or stop lamps to a trailer/sled.

The general kinematics of the motorized vehicle 1 is designed to ensure that it can optimally pass obstacles, as well as facilitate maneuverability for its user.

Since the connection between the vehicle 1 and the ground S is made up of planar contact in the region of the caterpillar track 32, and substantially punctual contact in the region of the steering skid 21 formed by the ski (considering that the ski can rotate freely with respect to the frame 32), it is essential for the frame 32 to have at least one internal degree of freedom in order to ensure the vehicle/ground isostatism in the case of a break in the gradient, in order to retain planar contact between the caterpillar track 32 and the ground S. FIG. 21 shows a configuration in which the isostatism is not adhered to, owing to too great a break in the gradient.

One solution would consist in placing a damper or suspension 20 between the front arm 24 and the ski 21. The internal degree of freedom would then be a translation of the same axis as the front arm 24 (see FIG. 22A).

This solution is practical and easy to implement for travel in urban surroundings for example, but is not sufficient to ensure good passage for the vehicle 1. Indeed, the greater the break in the gradient, the more the front suspension would have to be compressed in order for the planar contact in the region of the caterpillar track 32 to be guaranteed. Beyond a certain gradient, the force exerted on the front of the vehicle 1 (which is considered to be proportional to the course of the suspension of rigidity K) would be such that the balance of torques on the vehicle 1 would be incompatible with planar contact in the region of the caterpillar track 32.

Another solution would consist in connecting the front subassembly 2 to the rear subassembly 3 via a pivot connection having a horizontal axis in parallel with the transverse axis T (see FIG. 22B). It is thus necessary to damp the rotation between the two subassemblies by means of a suspension 20 in order to provide rigidity to the vehicle 1.

Even so, this is also not sufficient to ensure good passage for the vehicle 1 on some types of ground, in particular outside of urban regions. The rotation between the front part 2 and the rear part 3 is limited by the course of the damper. Beyond a particular gradient, the force applied by the damper and the front part 2 on the rear part 3 would cause said rear part to tip backward, and would limit the adhesion of the caterpillar track 32 with respect to the ground S.

In order for the internal rotation of the frame 32 not to be limited by the course of a damper 20, and in order to prevent detachment of the front of the caterpillar track 32 with respect to the ground S when ascending, the rear part 3 is provided with at least one internal degree of freedom. This is in particular the advantage provided by the degree of freedom, in particular the rotation, of the frame 32 bearing the driver, with respect to the lower bogie 82, the lower bogie 82 having at least one degree of freedom with respect to the upper bogie 81. This movement between the two lower 82 and upper 81 bogies is also referred to as “free rotation.”

The lower bogie 82 of the caterpillar track 81 is preferably connected to the frame 32 carrying the driver by at least two connection elements of the connecting rod 801 and/or suspension 802 type.

The relative rotation according to an axis in parallel with a transverse axis, between the lower bogie 82 and the frame 32, takes place about a point that is referred to as the virtual center of rotation (VCR) or instantaneous center of rotation (ICR), and is located at the intersection of the two elements (connecting rod and/or dampers) involved in the connection.

In the case of said two elements being in parallel (see for example FIG. 24C), the VCR is projected to infinity, and the relative movement between the lower bogie and the frame would be a translation. By a misnomer, this movement is referred to as a rotation in this case too.

In the case where the frame 32 is connected to the lower bogie 82 by two arms or connecting rods, the relative movement thereof is limited to just one degree of freedom (rotation according to the VCR).

In the case where the frame 32 is connected to the lower bogie 82 by two arms or connecting rods as well as by one or more suspensions, the relative movement thereof is limited for example to just one damped degree of freedom (rotation according to the VCR).

Alternatively, in the case where the frame is connected to the lower bogie 82 by one arm and one suspension (see FIGS. 241, 24B 26A and 26B), the relative movement thereof is limited to two degrees of freedom: a rotation according to the VCR, and the movement associated with the course of the jack of the damper.

Such a solution, having at least one degree of freedom, in particular has the advantage of providing the vehicle with a significant ability of passage—indeed, the isostatic kinematics of the vehicle 1 allows it to pass over significant breaks in the gradient (+−40%)), without momentum, since the planar contact of the caterpillar track 32 is ensured.

This kinematics, shown in greater detail with reference to FIGS. 23A to 23C and 25A to 25C, makes it possible to ensure a force on the ski 21, for any position of the passenger(s), from the time when the center of gravity of the suspended mass is toward the front with respect to the VCR.

Indeed, the position of the VCR is a parameter which makes it possible to vary the force on the ski. In order to maximize the force on the ski, it is desirable to move the VCR back as far as possible, hi order to reduce the risk of the frame 32 pitching up, which occurs when the center of gravity of the suspended mass is behind the VCR, the VCR is placed at the rear with respect to the rearmost position of the center of gravity, taking into account a configuration having just one passenger, sitting upright, and as far back as possible, on the saddle.

Preferably a strap is arranged and even interposed between the front of the frame 32 and the front of the lower bogie 82 in order to limit the respective rotation thereof (for example when climbing at a significant gradient, or under the motor forces).

Finally, in order to keep the caterpillar track 32 pressed on the ground, in particular in the case where the frame 32 is connected to the lower bogie 82 by two connection elements (arms, connecting rods, suspension), the bogie 8 is designed such that the VCR is located longitudinally in a zone Z located to the right, or vertically, with respect to the contact surface between the caterpillar track 32 and the ground S (see FIG. 25C).

Ideally in this case, in order to ensure homogeneous pressure of the caterpillar track 32 on the ground S, the VCR is located vertically to the center of the contact surface between the caterpillar track 32 and the ground S.

Furthermore, such kinematics having free rotation between the lower bogie 82 and the frame 32 is advantageous in that said free rotation cannot occur inadvertently (for example if the driver pulls the handlebars 22 back), since it is stabilized by the potential energy of the weight of the suspended mass. The free rotation upon the frame 32 pitching up requires the center of gravity of the suspended mass to be raised, of course provided that said center of gravity is at the front with respect to the VCR.

This kinematics also makes it possible to suspend the passenger(s) with connection elements between the frame 32 and the lower bogie comprising (at least) one suspension. For the comfort of the driver, the vehicle 1 also comprises a front suspension 20 as described above, borne by the front part 2.

A front suspension 20 of this kind is advantageous for damping the accelerations of the vehicle 1 and the passenger(s) during frontal impacts (which occur mainly during descent) or braking.

A suspension 20 of this kind also contributes to the overall kinematics of the vehicle 1. By carefully selecting the ratio between the front suspension 20 and the rear suspension 802, between the lower 82 and upper 81 bogies, it is possible to design the vehicle 1 such that the rotation of the frame 32 under the effect of the weight of the passengers is as small as possible, in order to improve the comfort of said passengers.

The front suspension also makes it possible to increase the ability of the vehicle 1 for passage. By simultaneously compressing, upon free rotation, the front suspension 20 allows the vehicle 1 to overcome, still in an isostatic manner, more significant breaks in the gradient than in the case of free rotation alone.

As described above, a front suspension 20 of this kind may be positioned either:
in a manner mounted so as to be rotatable between the front part 2 and the rear part 3 (see FIG. 26A) provided that the two front 2 and rear 3 parts are connected by a pivot connection having an axis in parallel with the transverse axis T; in this case, the steering column operates only in traction/compression under the forces associated with the passenger mass (ignoring the handlebar forces), and therefore does not have to be dimensioned under bending, which represents a benefit in terms of mass; furthermore, a front suspension of this kind operates only under compression, and therefore does not have to be dimensioned under bending, which represents a benefit in terms of mass; and/or,
more conventionally, between the steering column and the ski 21 (see FIG. 26B): since the front part 2 does not have any degree of freedom with respect to the rear part, the vehicle will be simpler to manufacture.

The caterpillar track 32 may be of different shapes, i.e. the closed loop delimited by the caterpillar track 32 may have a shape in the vertical plane (OLV) which differs according to the configurations.

The length of the bearing caterpillar track 32 defines the length of caterpillar track 32 in contact with the ground S in normal usage conditions of the vehicle 1. Since the caterpillar track 32 may represent a significant part of the mass of the vehicle 1, it is advantageous to have the greatest possible ratio of the bearing length to the total length.

One of the caterpillar track 32 shapes which guarantees this better bearing length to total length ratio, while guaranteeing an angle of attack, is the triangular caterpillar track. However, a quadrilateral caterpillar track 32 shape, visible in the figures, has an additional advantage of it being possible to place a rear upper pin at a height.

On account of using an articulated bogie 8, a constant perimeter of caterpillar track 32 during the movement of the lower bogie 82 with respect to the upper bogie 81 is not always guaranteed. Indeed, a reduction in the caterpillar track 32 perimeter brings about a reduction in the tension thereof, which may lead to a juddering phenomenon of the sprocket 813 with respect to the caterpillar track 32, and thus a loss of thrust or braking. Preferably, in this case, the bogie 8 is designed such that the connection elements (arms 801 and/or dampers 802) between the lower 82 and upper 81 bogies are positioned so as to limit the variation in the caterpillar track perimeter to a value that guarantees good driving of the caterpillar track 32 by the sprocket 813, when the lower bogie describes all the possible positions with respect to the upper bogie 81. This means that it is not necessary to equip the caterpillar track 32 with a dynamic tensioner (benefit in terms of mass, maintenance, reliability).

In a particular technical configuration, the VCR of the articulated bogie 8 is placed longitudinally between the axes B and C of the upper bogie 81, such that, under free rotation, the variation in the length of the front free strand 32AV of caterpillar track 32 compensates the variation in the length of the rear free strand 32AR.

The position of the VCR is selected for example empirically, between said two axes B and C, in order to achieve a compromise between:
bringing the VCR closer to the point C, which reduces the influence of the free rotation on the length of the rear free strand 32AR and increases the influence thereof on the length of the front free strand 32AV (see FIG. 25D); and
bringing the VCR closer to the point B, which reduces the influence of the free rotation on the length of the front free strand 32AV and increases the influence thereof on the length of the rear free strand 32AR.

The propulsion force of the vehicle 1 is transmitted from the sprocket 813, driven by the motor 5, to the ground S via the taut strand of the caterpillar track 32. The tension of the taut strand is the origin of the forces on the upper bogie 81 in the region of the sprocket 813 and at C in the region of the free wheels, and on the lower bogie 82 at D in the region of the free wheels.

In this context, and in order to limit the motor forces in the case of an articulated bogie 8, it is advantageous to limit the torque exerted on the lower bogie 82 at the VCR by the tension of the caterpillar track 32, and to place the V as close as possible to the straight line referred to as the “caterpillar track force line” which passes through the rear free strand (taut during forward travel), i.e. for example the strand extending from B to 1 and passing through the rear axes C and D of the lower 82 and upper 81 bogies for a caterpillar track 32 provided with four returns.

FIGS. 28 and 29 show two other embodiments. These embodiments differ, in substance, from the other embodiments above, mainly in that the vehicle comprises a propulsion means 32 of the caterpillar track type, driven by a transmission mechanism 4 designed to be driven by a motor 5, the motor 5 being received in a wheel 41 of the transmission mechanism 4 which forms a drive wheel of the propulsion means 32.

In this case, the motor 5 is remote from the remainder of the power units, said power units still being received inside the space delimited by the frame 31, under the saddle 33.

An example of such an in-wheel motor is illustrated in detail in FIG. 27A and

Since the motor 5 is directly integrated and received in a wheel 41 of the transmission mechanism, it is no longer necessary to use a drive belt 51 between a motor shaft 50 and a sprocket 813. Thus, in this case, the drive mechanism 4 is formed by the external envelope of the drive wheel designed for driving the caterpillar track 32 for example having a notched contour on the periphery thereof.

Said in-wheel motor may be arranged in the same place as the sprocket, with reference to the preceding figures, i.e. borne by the upper bogie 81, in the region of the front shaft thereof, at B (see FIG. 28).

An assembly of this kind, referred to as an “in-wheel motor,” which comprises a motor incorporated in a wheel (therefore direct driving) has in particular the following advantages:
no indirect transmission, of the chain or belt 51 type, is required, which is a benefit in terms of the number of pieces (and thus a benefit in terms of mass and assembly time), a reduction in maintenance and noise;
no indirect transmission of the chain or belt 51 type exposed to the outside environment, resulting in improved reliability;
the motor 5 is combined with the wheel, which results in reduced bulk.

On indirect-drive snowmobiles, i.e. in particular having a belt 51 or a chain interposed between the motor shaft 50 and the sprocket 813, said sprocket is preferably located in front of the upper bogie 81 (point B), the motor in turn being located in the body of the skidoo (between the saddle and the caterpillar track). This arrangement has the following advantages:
the angle made by the caterpillar track 32 in the region of the sprocket is acute. The contact surface (and thus the transmissible force) between the sprocket 813 and the caterpillar track 32 is thus larger than if the sprocket 813 were positioned in the region of an obtuse angle.
the sprocket is placed on the upper bogie which, like the motor, is rigidly connected to the frame. The motor axis and the sprocket axis are thus fixed with respect to one another (disregarding the structural deformations or mechanical backlash compensation). A chain, a pinion and a crown are thus sufficient for transmitting the force from the motor 5 to the sprocket 813.

There is no other position (than the position at point B) that guarantees the two following conditions:
the points A and C which, respectively, form the front return pin of the caterpillar track 32 in the region of the lower bogie 82, and the rear return pins of the caterpillar track 32 in the region of the upper bogie 81, are to be excluded since they correspond to obtuse angles, and the small sprocket/wheel contact surface would not allow for significant forces to pass;
the points D and A, which form the front and rear return pins of the caterpillar track 32 in the region of the lower bogie 82, are to be excluded since they are placed on the lower bogie 82. Since the upper 81 and lower 82 bogies are movable with respect to one another on a conventional skidoo (said mobility contributing to the rear suspension of the snowmobile), the center-to-center distance between the motor and the sprocket therefore will not be fixed (except in specific cases). Transmitting a force between the motor and the sprocket 813 would require a complex mechanism (mechanism comprising two chains, two pinions and two crowns, or single chain equipped with tensioner having significant travel in order to compensate the center-to-center distance variations, etc.) which is intensive in terms of mass, assembly time, and maintenance.

It will furthermore be noted that the fact of placing a conventional motor (non-wheel), the sprocket, and a chain (or belt) transmission on the lower bogie 82 may appear complex in terms of bulk, non-suspended mass, and sealing. Indeed, most conventional electric motors have non-sealed ventilation openings, in particular in order to ensure the cooling thereof and to prevent overheating.

However, this arrangement comprising a conventional motor (sprocket 813 at B, the point B forming the front return pin of the caterpillar track 32 in the region of the upper bogie 81), has the following disadvantages:
during forward travel, the taut strand of the caterpillar track 32 (i.e. the strand which passes from B to A, via C and then D) has a trajectory which includes two changes of direction (at C and at D). The free wheels (at C and D) which allow these changes of direction of the taut strand are subjected to significant forces (and friction), representing a loss of energy and thus a reduction in output. Likewise, the energy required for bending the taut strand around the wheels (C and D) also represents a loss of energy and a reduction in output (in the case of non-articulated rubber caterpillar tracks).
during forward travel, the taut strand exerts a force on the lower bogie 82 in the region of point D (according to the bisector of the angle CDA), taken up by the ground S (vertical force) in front of the bogie (close to point A), as well as by the connecting rods connecting the upper 81 and lower 82 bogies. The force exerted by the ground S increases the friction between the caterpillar track 32 and the lower bogie 82 in the zone of point A, which results in a reduction in the output.

In the case of an in-wheel motor 41, as well as the advantages intrinsic to the above-mentioned in-wheel motor, the in-wheel motor 41 applied to the skidoo has the following advantages in the configuration where the in-wheel motor is placed at D, i.e. rigidly connected to the lower bogie and placed therebehind (see FIG. 29):
during forward travel, the taut strand between points A and D, located below the lower bogie 82, has a trajectory that does not include any change in direction: this increases the output compared with the provision of indirect driving;
during forward travel, the taut strand does not exert any significant force on the lower bogie 82: there is therefore no increase in the vertical force of the ground in front of the lower bogie 81, which increases the output compared with the provision of indirect driving;
since the in-wheel motor 41 is cooled directly, by means of the contact with the snow, the risks of overheating are reduced (advantage compared with the motors placed in the body of the skidoo and cooled only by air, and compared with in-wheel motors equipping land vehicles not intended for movements on snow);
since the in-wheel motor 41 is not located in the body of the snowmobile, the casing of the skidoo 1 is thus simplified (no ventilation circuit, on dynamic sealing element for the motor shaft, and may be entirely closed (no risk of short circuit), simplicity of assembly, reduction in maintenance;
the shaft 812 is no longer necessarily mounted so as to be rotatable with respect to the upper bogie or to the frame 31, which reduces the number of pieces, and simplifies the assembly and the maintenance of the vehicle. The free wheels at B are thus mounted on ball bearings, with respect to the shaft 812.
the mass of the in-wheel motor is not suspended, but is not directly subjected to impacts in the event of unevenness of the ground, since the motor is located at the rear of the lower bogie, which protects it from some of the impacts: the in-wheel motor is advantageously raised with respect to the lower bogie 82/caterpillar track 32 contact line, in order to not be in contact with the ground (via the caterpillar track 32), which makes it possible to protect it from more direct impacts.

More specifically, in this embodiment the driving sprocket is a conventional in-wheel motor, from which the spokes or tire have been removed, and to which a drive pinion (or sprocket) is rigidly connected. The driving elements of the sprocket that form the transmission mechanism 4 (teeth or notches for example, see FIGS. 27A and 27B) are designed to be engaged in the driven elements of the caterpillar track. The shaft of the driving sprocket is fixed with respect to the lower bogie 81 of the vehicle 1.

The main differences of this embodiment compared with a vehicle having an indirect drive are, essentially, the following:
the casing of the motor unit, rigidly connected to the frame 31, does not contain a motor 5, said motor being directly engaged on the caterpillar track 32;
the driving sprocket 41 is still connected, by sealed cables, to other power units (controller, batteries, electronics) located in the casing that is rigidly connected to the frame;
the shaft 5 of the in-wheel motor 41 or driving sprocket 41, which does not rotate in the referential of the vehicle 1, is rigidly connected to the lower bogie 82;
the braking of the vehicle 1 is ensured by means of a brake such as a disk brake that is rigidly connected to the rotating part of the driving sprocket 41, and the jaws of which are rigidly connected to a fixed point of the lower bogie 82.

According to the configuration shown in FIGS. 41A and 41B, the frame 31 has at least four oblong half holes on the lower part thereof, in this case four, i.e. two on either side, in particular on the lower free edge thereof, as well as an excess thickness (or flanged edge) formed by a transverse extrusion with respect to the frame 31. The front (B) and rear (C) pins of the upper bogie 81 are threaded at the two ends thereof, allowing for a nut and a washer (not shown) to be fixed. The two oblong half holes that are open at the bottom can thus each receive one end of the pins (B), (C) of the upper bogie 81, and the tightening of the (at least) four nuts thus renders the upper bogie 81 rigidly connected to the frame 31. The excess thickness (or flanged edge) in the vicinity of the oblong half holes makes it possible to ensure that the connection is maintained (by blocking the nuts/washers in translation) in the event of slight unscrewing of the nuts). When the four fixings are removed, the frame 31 can be easily dismantled from the caterpillar tracked train by lifting it vertically.

As for the vehicle having an indirect drive, the lower bogie 82 is connected to the upper bogie 81 by means of a suspension mechanism 80, in particular at least one connecting rod and one suspension, positioned so as to minimize the variation in the perimeter of the caterpillar track 32 in the event of the relative movement of the upper 81 and lower 82 bogies. A configuration having this advantage is shown in FIG. 35.

As for the vehicle having an indirect drive, there is a variant having a damped fork.

FIGS. 30, 31, 32, 33, 34 and 35 are general and detailed views of a motorized vehicle 1 according to a variant.

In particular, the front arm 24 of the front part 2 comprises a rotatably mounted column inside a steering tube that is rigidly connected to the linkage 23. The front part 2 further comprises a damper or suspension 20 arranged between the front arm 24 and the ski 21. More specifically, the lower end of the front arm 24 comprises a fork onto which the suspension 20 is fitted. The linkage 23 is designed such that it can be dismantled, and is formed of a plurality of elements or pieces. This allows for the linkage 23 to be dismantled and packaged in the form of a kit, for the transport thereof.

These pieces are interconnected by fitting, in this embodiment, and secured by detachable mechanical fixing means, preferably comparable with the detachable connection means, such that all these pieces can be easily dismantled.

The linkage 23 of the front part 2 is connected to the frame 31 of the rear part 3 by means of the detachable mechanical connection 6.

Said detachable fixing comprises two pivot connections that are superimposed vertically and connected to the linkage 24. On account of the presence of two pivot connections between the linkage 23 of the front part 2 and the frame 31 of the rear part, there is no degree of freedom between said two assemblies, the linkage 23 having no internal degree of freedom. Each of said two pivot connections is provided with a gripping means 61, said gripping means comprising a handle, referred to as a wing nut, which is rigidly connected to the swivel pin and secured by a push button.

Alternatively or in addition, the detachable mechanical connections 6 of this variant comprise a detachable mechanical fixing means, for example of the screw-nut type, which can be dismantled using a simple tool, such as a standard screwdriver.

In this configuration, the motorized vehicle comprises an in-wheel motor 41.

In this case, the shaft of the in-wheel motor 41 (rigidly connected to the stator of the lower bogie 82 (also referred to as rail or slide). The lower bogie 82 is thus subjected to antagonistic forces (Newton's third law) of the forces exerted by the in-wheel motor 41 on the caterpillar track 32.

In the region of the shaft/lower bogie 82 connection, this torsor is made up of the motor torque and the propulsion force. These forces balance out by means of the upper bogie 81 (via the connecting rods 90 and/or suspensions 91), and the vertical reaction of the ground S. This reaction of the ground S brings about a local increase in the friction, which results in a decreased output.

In order to limit this phenomenon and to guarantee a homogeneous contact pressure between the lower bogie 82 and the caterpillar track 32, it is desirable to reduce, as far as possible, the vertical component of the reaction of the ground S on the lower bogie 82 under the motor forces.

In this context, it is advantageous to position the VCR on a straight line referred to as the “caterpillar track force line” L (see FIG. 35) which is colinear with the resultant of the propulsion forces exerted by the in-wheel motor 41 on the caterpillar track 32 (see FIG. 35, in which said straight line is considered to be horizontal). The vertical reaction of the ground S is thus zero. Regulation means such as oblong holes in the region of the lower bogie 82/connecting rod, lower bogie 82/suspension connections make it possible to move the VCR above or below this straight line of equilibrium L. This has the advantage that it is possible to regulate the distribution of pressure along the lower bogie 82 under the motor force, and it is possible to select to load/unload the front or the rear of the lower bogie 82, depending for example on the position of the center of gravity of the onboard mass (in particular the driver and, if applicable, the passenger(s)).

An advantageous provision consists in making the caterpillar track configuration triangular, i.e. in this context having three return points of the caterpillar track 32, in the following manner:
a drive at the rear lower peak of the caterpillar track 32, at the rear of the lower bogie 82, via the in-wheel motor 41 as shown in these drawings;
a free wheel 813′ at the upper front peak, at the front of the upper bogie 81, connected by a connecting rod 90 to the lower bogie 82, referred to as the “front connecting rod”;
a “waiting” free wheel 811′, positioned at the rear of the upper bogie 81. Said wheel 81 does not operate in the normal operating configuration, but in some configurations, such as significant breaks in the gradient (FIG. 36C) or in order to stabilize the slack strand at a high speed of rotation of the caterpillar track 32. Thus, in this case, a free wheel of this kind does not change the triangular nature of the caterpillar track 32 during standard use.

In addition to the advantages of rear driving, cited above, this triangular configuration has the advantage of having a caterpillar track perimeter which depends on only one single degree of freedom; the angle between the lower bogie 82 and the front connecting rod 90. The perimeter of the caterpillar track 32 is thus independent of the angle between the lower and upper bogies (in the “normal” configuration where the rear wheel of the upper bogie is waiting). It is thus possible to position a suspension 91 between the upper 81 and lower 82 bogies in order to damp the vehicle, without the compression/relaxation thereof causing relaxation/tensioning of the caterpillar track 32 (see FIGS. 37A and 37B).

Finally, in the configuration set out above, this suspension operates under traction and not under compression, under the motor forces during forward travel, which prevents an unnecessary loss of energy.

The lower pivot of the front connecting rod 90 is positioned so as to limit the variation in the caterpillar track 32 perimeter to a value that guarantees good driving of the caterpillar track 32 by the sprocket, when the lower bogie describes all the possible positions with respect to the upper bogie 81, according to the single degree of freedom mentioned above. This means that it is not necessary to equip the caterpillar track 32 with a dynamic tensioner (a benefit in terms of mass, maintenance, reliability).

The static regulation of the tension of the caterpillar track 32 is achieved by virtue of the oblong holes of the lower bogie 82 (lower bogie 82/in-wheel motor 41, or lower bogie 82/connecting rod 90 connection). A screw/nut system allows the motor pins and connecting rods to be blocked in translation, at the desired position.

In a variant (FIG. 41B) of the above triangular caterpillar track configuration, the anchor point (pivot) of the connecting rod 90 to the upper bogie 81 is moved back with respect to the free wheel 813′, and an additional suspension 91A may be placed upstream of the connecting rod 90. In a particular technical configuration, said pivot point is positioned so as to be equidistant (variable in a range of +/−20% of the length of the upper bogie 81 with respect to said equidistant point) from the front 813′ and rear 811′ wheels of the upper bogie 81, and is located in the vicinity (less than 10% of the length of the upper bogie 81) of the upper pivot of the front suspension 91A. Thus, in the case of decompression of the rear suspension 91B (for example in the case of a break in the gradient), the relative rotation of the upper 81 and lower 82 bogies will be about the VCR positioned close to the center of the upper bogie 81. The movement of the free wheel 813′ tends to relax the caterpillar track 32, whereas that of the wheel 811′ (which was waiting) tightens the caterpillar track 32. This configuration limits the variation of the perimeter of the caterpillar track in the case of breaks in the gradient, and thus the juddering of the sprocket.

In a particular configuration of the variant (FIG. 41B), the axis formed by the rear suspension (axis passing through the two pivots of the suspension) and the axis of the connecting rod 90 (axis passing through the two pivots of the connecting rod 90) intersect at a point positioned at (or close to) the bisector of the front upper angle of the caterpillar track 32 (that formed by the free wheel 813′). Thus, in the case of the compression/decompression of the front suspension (for example in the case of ground unevenness), the relative rotation of the upper 81 and lower 82 bogies will be about the VCR positioned close to said bisector. This configuration limits the variation of the perimeter of the caterpillar track 32 in the case of breaks in the gradient, and thus the juddering of the sprocket.

In a particular configuration of the variant (FIG. 41B), the upper pivot of the rear suspension is coaxial to the wheel 811′.

The translation of the driving sprocket 41 (and thus of the disk brake rigidly connected to the rotating part of the driving sprocket 41) with respect to the lower bogie 82 (and thus to the jaws of the disk brake, rigidly connected thereto) would bring about distancing of the disk with respect to the jaws, and thus poor braking (reduction in the contact surface thereof). Advantageously, the jaws of the disk brake, rigidly connected to the lower bogie 82, can thus also be translated via oblong holes on the lower bogie 82, in the region of zones 410. A screw/nut system allows the jaws to be blocked in translation, at the desired position.

The in-wheel motor 41 or driving sprocket may be subjected to direct impacts (for example caused by ground unevenness), despite the motor 5 being raised with respect to the ground. These impacts may damage the internal elements of the motor 5 (electronic or mechanical), cells 411 may be formed on the circumference of the wheel 41 or sprocket (on a strip located between the outer and inner peripheries of the sprocket). The function of these cells 411 is to reduce the radial rigidity of the wheel 41. The material remaining between two successive cells is referred to as the stiffener 412. Said cells 411 are preferably distributed regularly over the annular extent of the wheel 41.

Adding cells 411 necessarily reduces the rigidity of the wheel 41 under torsion, and thus its mechanical output for the transmission of motor forces. This may have a significant impact on the autonomy of the vehicle 1.

Thus, a cell 411 shape will be selected which promotes the reduction of the radial rigidity of the wheel 41 (to damp the radial impacts) rather than the reduction of its rigidity under torsion (to limit the drop in mechanical output of the in-wheel motor 41).

An advantageous solution is that of selecting a cell 411 shape such that the stiffeners 412 are inclined with respect to the radial direction of the wheel 41. Thus, the stiffeners operate under bending, under the effect of direct impacts resulting from ground unevenness, and operate under traction/compression under the motor forces. If the stiffeners 412 were oriented according to the radial direction of the wheel 41, they would operate exclusively under compression, under the effect of direct impacts resulting from ground unevenness, and would operate under bending, under the motor forces. Since the rigidity of a solid beam is lower under bending than under traction/compression, the solution having inclined stiffeners is thus more advantageous.

FIG. 41A shows a cell 411 shape of this kind.

The in-wheel motor 41 or driving sprocket may be subjected to direct impacts, as well as to high vertical accelerations (for example when receiving jumps). Since these impacts may damage the internal elements of the motor 5 (electronic or mechanical), joints 413 having a low Young's modulus (less than 10 GPa, for example made of elastomers) are placed between the axis of the motor 5 and the lower bogies 82 (in particular in the oblong hole of the lower bogies). The function of these joints 413 is to reduce the vertical rigidity (according to Z skidoo) of the bogie 8-motor 5 connection.

It would not be sensible to place said joints 413 directly against the axis of the shaft, since they would caulk under the motor torque, and this would reduce the mechanical output of the motor 5-bogie 8 connection (and thus maximum transmissible torque). This is why plates 414, made of a material harder than that of the joints 413, are placed between the axis of the motor and said joints. The function of said plates is to make a greater length of the joint operate under the motor forces (reduction in caulking by increasing the surface) and to increase the lever arm of the recovery of the motor torque by the joint (reduction in caulking by reducing the force).

The motor axis is thus placed in the following sandwich configuration: bogie 8-joint 413-plate 414-motor axis-plate 414-joint 413-bogie 8.

FIGS. 38 and 39 are side and perspective views of a motorized vehicle according to another embodiment. In particular, in this embodiment, the front part 2 is comparable to that described with reference to FIGS. 30 to 33, and the rear part 3 has an indirect drive comparable to that described above.

In a general manner, whatever the mode of implementation retained, friction at the pivot connections can be reduced by using bearings.

The invention described above thus has a large number of advantages.

The format of the motorized vehicle offers, for example, a number of advantages to its user.

The user's seat is low, and it is possible for the users to place both feet on the ground, providing a sense of safety. This makes the vehicle more accessible to the general public than is the case for conventional snowmobiles.

The front part of the vehicle can be separated from the rear part without tools, making it possible to transport said vehicle in a car or on public transport.

All the heavy elements (motor, batteries and other power means) are placed in the rear part, which may be equipped with castors without tools), which facilitates transportation on foot.

The front part can be dismantlable in order to be easily transportable in a rucksack made of waterproof fabric.

The rear part 3 is preferably self-supporting. Indeed, if the distribution of the elements of the rear unit is such that the center of gravity thereof is located above the vertical of the furthest forward ground/caterpillar track contact point, tilting would take place when dismantling the front unit. In order to overcome this, two feet are placed between the pin B and the ground (the front transport wheels are then unusable).

The rear part comprises a device that makes it possible to fix retractable castors thereon, as well as a handle.

The user can thus move the equipment by rolling the rear part and carrying the front part. The front part could also be fixed on the rear part, in order to avoid the user carrying a bag during transport of the equipment. The rear part may be covered by a sealed fabric cover in order to contain, during transport or storage, snow, water, mud, or other particles which have soiled the equipment during its use. The design of the equipment is such that the user can easily transition from the “transport” mode to the “driving” mode within a few minutes.

The user can transition from the “transport” mode to the “driving” mode and vice versa without any element other than the transport castors and the fixing device thereof, the storage bag of the front part, and optionally the protective cover of the rear part. Since these different transport accessories may be contained in the rucksack of the front part, the user can transport them with him when driving the equipment. This device is intended to be able to allow the user to easily transition from the “driving” mode to the “transport” mode and vice versa, during use of the equipment. This contributes to the equipment's characteristic of being nomadic. For example, this makes it possible for the user to be able to store the equipment in their apartment, to move the equipment to their car parked in the parking lot, or to use a gondola, an elevator, or other public transport means with the equipment.

Its format also offers new commercial possibilities such as mail-order selling.

The electric motorization is also advantageous in that it is silent, which makes it suitable for urban and nighttime travel for example, and non-polluting, allowing it to access protected nature reserves.

Furthermore, since the torque of an electric motor may be very significant upon start-up, the vehicle is not equipped with a gearbox, as for a combustion engine vehicle, which provides a benefit in terms of mass.

Furthermore, the kinematics of the vehicle is designed to ensure it a significant ability of passage, without it being necessary to gain momentum, ensuring the user more flexible driving, suitable for the general public.

The pivot connections with which the front part is equipped make it possible to operate the frame elements under traction/compression rather than under bending, which also allows for a benefit in terms of mass.

The invention is described above by way of example. It will be understood that a person skilled in the art is able to implement different variants of the invention, without in any way departing from the scope of the invention.

1. A motorized vehicle comprising:
a front part provided with at least one steering skid intended to be steered by handlebars,
a rear part comprising a frame that is rigidly connected to a propulsion means of the caterpillar track type, and driven by a transmission mechanism that is designed to be driven by a motor,
wherein the motor is received in a wheel of the transmission mechanism which forms a drive wheel of the propulsion means, the propulsion means being supported by a bogie, the bogie comprising an upper bogie which is rigidly connected to the frame, and a lower bogie, which bogies are interconnected by a suspension mechanism, the lower bogie having at least one degree of freedom with respect to the upper bogie, said wheel of the transmission mechanism forming a drive wheel of the propulsion means being rigidly connected to the lower bogie at the rear thereof.

2. The motorized vehicle according to claim 1, further comprising:
a mechanical connection for mechanically connecting the front part to the rear part, the mechanical connection being detachable.

3. The motorized vehicle according to claim 2, further comprising:
a gripping means that is designed to allow for the manual assembly and dismantling of the mechanical connection.

4. The motorized vehicle according to claim 1, wherein the motor is an electric motor that is supplied by a battery.

5. The motorized vehicle according to claim 1, wherein the front part comprises a linkage which forms a framework, the detachable mechanical connection connecting the linkage of the front part to the frame of the rear part.

6. The motorized vehicle according to claim 5, wherein the front part comprises a front arm that is of a fork type, connected on one side to the steering skid and on the other side to the handlebars, the linkage being rigidly connected to the front arm and being designed such that it can be dismantled, and/or being articulated so as to be foldable.

7. The motorized vehicle according to claim 1, wherein the detachable mechanical connection is articulated so as to ensure a pivot connection having a horizontal axis extending transversely with respect to a longitudinal reference axis of the vehicle.

8. The motorized vehicle according to claim 1, wherein the handlebars comprise electrical control means of the motor, and in that the motorized vehicle comprises an electrical connection device between the front part and the rear part.

9. The motorized vehicle according to claim 1, wherein the rear part is self-supporting.

10. The motorized vehicle according to claim 1, wherein the lower bogie has at least one degree of freedom with respect to the upper bogie, the degree of freedom of the lower bogie with respect to the upper bogie is preferably a rotation about an instantaneous axis of rotation, preferably located longitudinally with respect to the motorized vehicle in a zone located to the right of a contact surface between the propulsion means and the ground.

11. The motorized vehicle according to claim 1, wherein, in a storage position, a combined measurement of a length and a circumference of the vehicle is less than or equal to 419 cm.

12. The motorized vehicle according to claim 1, wherein the bogie is designed such that the caterpillar track is triangular having three returns.

13. The motorized vehicle according to claim 1, wherein the wheel of the transmission mechanism inside which the motor is received comprises, on its circumference, a plurality of cells which are separated by stiffeners, the stiffeners preferably being inclined with respect to a radial direction of the wheel.

14. The motorized vehicle according to claim 1, wherein the wheel of the transmission mechanism inside which the motor is received is borne by a shaft connected to the lower bogie, at least one cushioning gasket being arranged between the shaft of the wheel and the lower bogie, preferably accompanied by at least one plate made of a harder material than the joint.

15. The motorized vehicle according to claim 1, wherein the frame comprises at least four oblong half holes which are designed to receive portions, preferably located at the ends, of at least two shafts borne by the bogie, preferably by the upper bogie.
